(19) United States
(12) Patent Application Publication
(10) Pub. No.: US 2015/0066763 A1
(43) Pub. Date: Mar. 5, 2015

(54) METHOD AND APPARATUS FOR CROSS CHANNEL MONITORING

(71) Applicant: Bank of America Corporation, Charlotte, NC (US)

(72) Inventor: Sounil Yu, Reston, VA (US)

(73) Assignee: Bank of America Corporation, Charlotte, NC (US)

(21) Appl. No.: 14/014,182

(22) Filed: Aug. 29, 2013

(51) Int. Cl. G06Q 20/38

(52) U.S. Cl. CPC G06Q 20/38
USPC 705/44

(57) ABSTRACT

Methods and apparatuses for detecting nefarious activity by providing to others false information and tracking the use of the false information to determine in what way unlawfully taken information is used across several banking channels are presented. An example system can be configured to introduce certain predetermined markers into account data when it is determined that a user's account has been compromised, for example, during an online banking session. In this way, when a party unlawfully takes the user's account information, that party will also copy the markers from the user's account data. Therefore, when the party attempts to use the user's account data, the party will also include the markers added to the user's account. The markers can be information that is added that does not affect the transaction so the transaction can be conducted, and the system can recognize that the transaction may be nefarious.

### FIELD

Aspects of the disclosure generally relate to detecting unauthorized access of user accounts and monitoring in what manner information is unlawfully taken. More specifically, aspects of the disclosure provide methods and apparatuses for detecting nefarious activity by providing false information to unscrupulous parties and tracking the use of the false information to determine in what ways legitimate information may be unlawfully taken.

### BACKGROUND

Unscrupulous parties can use many different methods to obtain money, assets, or other property owned or held by a financial institution and/or the financial institution's customers. Examples may include, check kiting, payment/credit-card scams, and ancillary schemes such as phishing, internet deception, and the like. Additionally, other activities may rise to the level of suspicious activity that may be associated with various nefarious acts or activities. In this regard, the suspicious activity, if identified, may be helpful in identifying unscrupulous parties, the location of unscrupulous parties or other information pertinent to nefarious activity, such as telephone numbers, Internet Protocol (IP) addresses and the like.

These suspicious activities may include, but are not limited to, bank transactions, such as deposits, withdrawals, loan transactions and the like; credit card transactions; online banking activity such as compromised online banking IDs and the like; electronic commerce activity; call center activity and the like. Additionally suspicious activity may include computer security violators, deceptive telephone calls, and entities associated with divisive computer programs (e.g., viruses, trojans, malware and the like).

Additionally, unscrupulous parties may operate phishing scams to unlawfully take personal information, such as usernames, passwords, addresses, credit card information, and ultimately money by disguising themselves as a trustworthy entity. For example, unscrupulous parties may lure victims by electronic correspondence seemingly from financial institutions, social websites, auction websites, online payment processors, or IT administrators. Victims may receive emails with links to fake webpages that appear to be authentic. These fake webpages typically request the victim to verify information by entering personal information into various information requests on the website. In this way, the user will believe that a legitimate source requested this information, and the user will enter the requested information into the fake webpage. The unscrupulous party can then unlawfully take this information and can ultimately unlawfully take money from the victim or sell the account information to another unscrupulous party who may try to commit check scams or otherwise try to unlawfully take the assets from the users' accounts, which tend to be account holders with higher levels of assets. For example, the unscrupulous party may unlawfully take money from the victim by using various channels, such as ATMs, bank branches, mobile banking, online banking, and the like.

In some instances, financial institutions may have trouble recognizing ongoing scams or other nefarious activities until the scam or crime has escalated to a level that has a large financial impact. Also, in certain instances, it may be difficult to distinguish at what point and which banking channel the unscrupulous party received the victim's account information.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

In one example, a system can be configured to introduce certain predetermined markers into account data when it is determined that a user's account has been compromised, for example during an online banking session. In this way, when the unscrupulous party unlawfully takes user account information, the unscrupulous party will also copy the markers from the user account data. Therefore, when the unscrupulous party attempts to use the user account data, the unscrupulous party will also include the markers added to the user account. In one example, the markers can be information that is added that does not affect the transaction so the transaction can be conducted, and the system can recognize that the transaction may be nefarious. Alternatively, the system can detect the markers and can prevent the transaction from occurring. In certain instances, it may be beneficial for the financial institution to understand where the victim's information was unlawfully taken to better understand how the scam occurred to better limit nefarious transactions. For companies that host accounts, such as financial institutions, it is very difficult to determine which users are being targeted by phishing scams and whether an unscrupulous party has taken user information because the victim often gives personal information directly to the unscrupulous party through phishing websites. Thus, by using markers (e.g., as in the example above and in the other examples discussed herein), a financial institution may be able to determine how and where a victim's information was unlawfully taken.

In another example, an apparatus may include a processor and a memory for storing computer readable instructions that, when executed by the processor, can cause the apparatus to perform a method of screening a user account for nefarious activity. The method may include adding one or more markers into account information of the user account, scanning for the one or more markers in transactions of the account across a plurality of transaction channels, and identifying, displaying, or reporting any transactions across the plurality of transaction channels that are conducted with the one or more markers.

### BRIEF DESCRIPTION OF THE DRAWINGS

A more complete understanding of the present disclosure and the advantages thereof may be acquired by referring to the following description in consideration of the accompanying drawings, in which like reference numbers indicate like features, and wherein:

FIG. 1 illustrates one example of a network architecture and data processing device that may be used to implement one or more illustrative aspects discussed herein.

FIG. 2 illustrates a flow diagram for an exemplary process disclosed herein.

### DETAILED DESCRIPTION

In the following description of the various embodiments, reference is made to the accompanying drawings, which form a part hereof, and in which is shown by way of examples various embodiments in which the disclosure may be practiced. It is to be understood that other embodiments may be utilized and structural and functional modifications may be made without departing from the scope of the present disclosure. The disclosure is capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. For example, the use of “including” and “comprising” and variations thereof is meant to encompass the items listed thereafter and equivalents thereof as well as additional items and equivalents thereof, and the use of the terms “mounted,” “connected,” “coupled,” “positioned,” “engaged” and similar terms, is meant to include both direct and indirect mounting, connecting, coupling, positioning and engaging.

As noted above, various aspects of the disclosure relate to cross channel scam tracking. Before discussing these aspects in greater detail, however, several examples of a network architecture and a data processing device that may be used in implementing various aspects of the disclosure will first be discussed.

I. Detailed Description of Example Network Architecture and Data Processing Device that May be Used to Implement Cross Channel Scam Checking

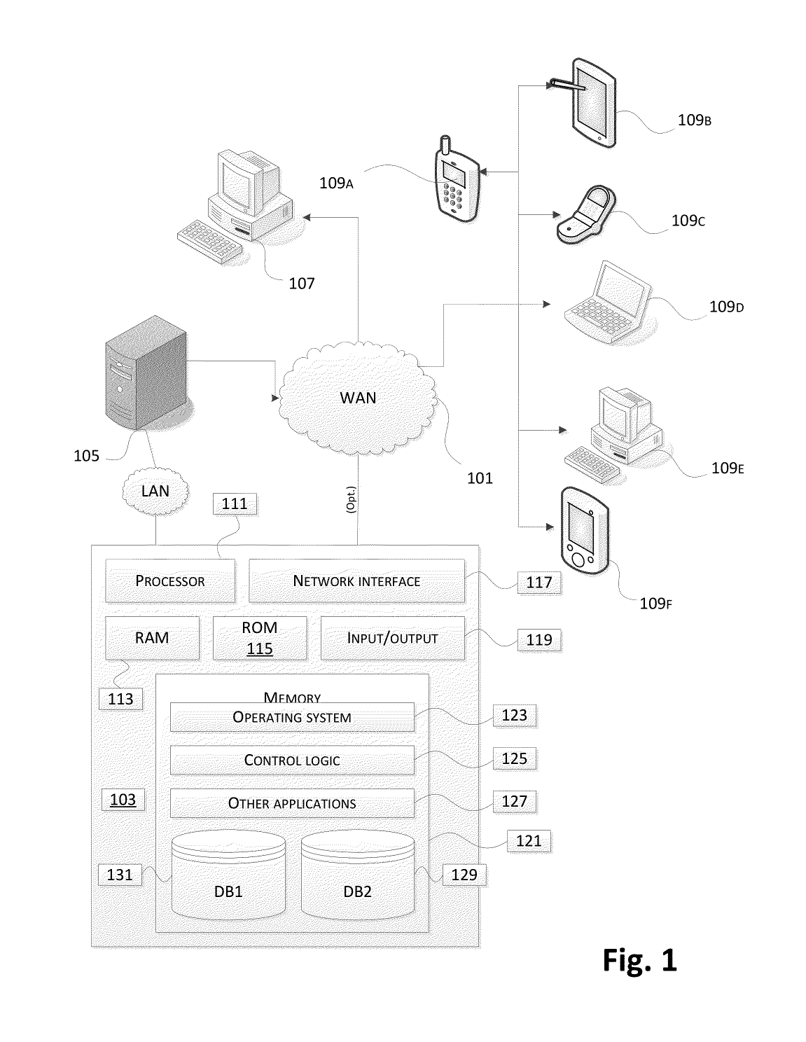

FIG. 1 illustrates one example of a network architecture and data processing device that may be used to implement one or more illustrative aspects. Various network nodes 103, 105, 107, and 109A-F may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109A-F and other devices (not shown) may be connected to one or more of the networks via twisted pair wires, coaxial cable, fiber optics, radio waves or other communication media. For example, the above connections can be made via the internet, blue tooth, WiFi, infrared, or any other known method of wireless transmission.

As shown in FIG. 1, devices 109A-F may include personal computers such as desktops, laptops, notebooks, mobile telephones or smartphones with applications and other functionality, a handheld device with Wi-Fi or other wireless connectivity (e.g., wireless enabled tablets, tablet computers, PDAs, and the like), displays with built-in or external memories and processors, or any other known computer, computing device, or handheld computer can also be connected to one or more of the networks described herein. It is also contemplated that other types of devices such as ATMs, kiosks, and other cash handling devices can be connected to one or more of the networks described herein. These devices can be enabled to communicate with wireless access points which in one example can be a series of cellular towers hosted by a service provider. Additionally, the wireless access points may be Wi-Fi (e.g., compatible with IEEE 802.11a/b/g/and the like wireless communication standards) connections and the computing devices may obtain access to the Internet at these connections. Other known techniques may be used to allow devices to connect with a network.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, and devices 109A-F. Data server 103 provides overall access, control and administration of databases and control software for performing one or more illustrative aspects as described herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, devices 109A-F, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 or devices 109A-F a user may access web server 105 using an Internet browser, as is known in the art, or by executing a software application or app that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device as discussed herein. Data server 103, e.g., may include a processor 111 controlling overall operation of the rate server 103. Data server 103 may further include RAM 113, ROM 115, network interface 117, input/output interfaces 119 (e.g., keyboard, mouse, display, printer, or the like), and memory 121. I/O 119 may include a variety of interface units and drives for reading, writing, displaying, and/or printing data or files. Memory 121 may further store operating system software 123 for controlling overall operation of the data processing device 103, control logic 125 for instructing data server 103 to perform aspects as described herein, and other application software 127 providing secondary, support, and/or other functionality which may or may not be used in conjunction with one or more aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, or the like).

Memory 121 may also store data used in performance of one or more aspects, including a first database 129 and a second database 131. In some embodiments, the first database may include the second database (e.g., as a separate table, report, or the like). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109A-F) as described herein may be spread across multiple data processing devices, for example, to distribute processing load across multiple computers, to segregate transactions based on geographic location, user access level, quality of service (QoS), or the like.

One or more aspects may be embodied in computer-usable or readable data and/or computer-executable instructions, such as in one or more program modules, executed by one or more computers or other devices as described herein. Generally, program modules include routines, programs, objects, components, data structures, or the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, or the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

II. Detailed Description of Example Cross Channel Scam Checking Methods and Systems

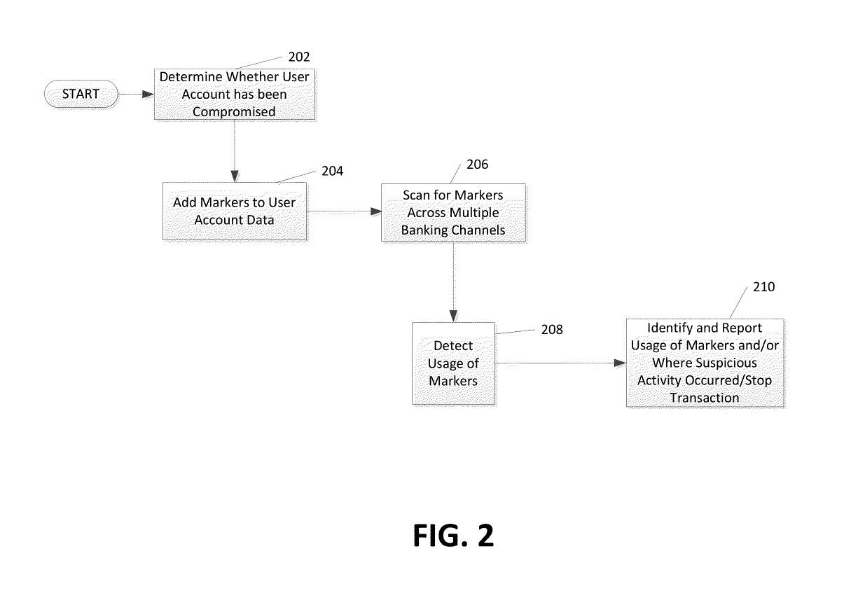

FIG. 2 shows an exemplary flow chart of a system for detecting scams across multiple channels. The system can be configured to enter in spurious information or markers into a user's account information once it is detected that the user's account information is being viewed by an unscrupulous party to determine and monitor how certain scams are carried out by unscrupulous parties. In some embodiments, the system may implement one or more aspects of the data processing device discussed above (e.g., the system may include one or more processors, one or more memories storing computer-readable instructions, and/or the like). Initially, the system may determine whether the user's account has been compromised at step 202. The system can make this determination by monitoring for account peeking or detection of a divisive software (e.g., viruses, trojans, malware and the like) on the user's device, as described in further detail below in addition to other known techniques. Once the system detects that an account has been compromised, the system can then add one or more markers to the account data in step 204. In this way, when the unscrupulous party unlawfully takes the user's account information, the unscrupulous party will also copy the markers from the user's account data.

Thus, when the unscrupulous party attempts to use the user's account data, the unscrupulous party will also include the one or more markers added to the user's account. The system can be configured to scan for this spurious information that is inserted into the user's account and can detect the spurious information. In particular, the system at 206 can scan for the one or more markers added into the user's account information by monitoring various transactions of a compromised account across a plurality of banking channels e.g. ATMs, bank branches, mobile banking, online banking, and the like, and can detect at step 208 whether any transactions include the one or more markers. Once the system detects that the markers have been used in a particular transaction, the system can at step 210 identify, report, and/or display that markers were used to conduct the transaction to the appropriate personnel, and identify, report and/or display where the user's information was compromised by reviewing where and when the markers were added to the account information. In this way, the system can be used to detect scams across multiple banking channels and provide details on where suspicious activity has occurred. For example, the one or more markers in the account number can be added when the account is accessed online, and the markers can be detected during a checking transaction. The system may also in certain instances be configured to stop or cease the transaction from being performed automatically when the one or more markers are detected.

It is contemplated that the one or more markers or spurious information added to the user accounts can take on many forms. For example, the markers can be any combination of letters, numbers, or symbols that are added to user accounts when suspicious activity associated with the user accounts is detected. The system can be configured to randomly include certain markers in the user accounts to best conceal the presence of the markers to the unscrupulous party. The system can also be configured to store and save when the user accounts are accessed with the one or more markers present in the user accounts' information.

In one example, markers, such as extra zeros, can be added to an account number of a bank account. For example, the extra zeros can be added in front of an eleven digit account number. Once a transaction is conducted with the additional zeros, the system can determine that the transaction was nefarious and can determine where the scam occurred, such as through an online or mobile banking transaction. In this way, the system can determine where and at what point the information was likely taken from the user. By determining the point at which the information was unlawfully taken from the user, the system can be configured to detect scams across multiple channels, for example, online, mobile, ATM, and the like. Using this information, information technology personnel can determine how to best combat the issues of scams against user accounts.

In one example, the unscrupulous party may using the marked account information try to create checks in the legitimate account holder's name to misappropriate the funds in the user's account. Because spurious information is added to the account information the unscrupulous party will print out checks with the spurious information on the check. When the check gets cashed, the system can flag the bad check. In this way, the system can be configured to monitor when bad checks are cashed to monitor scams across different channels, e.g., online banking, ATM transactions, checking, and the like. In addition or alternatively, the system can be configured to stop the check from being cashed by the unscrupulous party when the markers are detected.

In another example, the system can be configured to add markers to email addresses of account holders where the system detects nefarious activity associated with a user account. For example, certain email address domains ignore periods when inserted into email addresses. Therefore, with these particular domains, the system can add spurious periods into email addresses without affecting the email traffic to the user. In another example, the addition of a “+” marker after the user's email address and before the “@” does not affect the email traffic to a user. Therefore, in this example, spurious information can be inserted after the “+” marker and the use of the email address with the spurious information can be tracked to determine when potential scams have occurred. The email address markers can be leveraged across various channels, e.g. online, checking, ATMs, and the like, to determine when a potential scam occurs. For example, these markers can be used to locate a phishing scam. In particular, when a unscrupulous party attempts to log into a user's account using the marked email address, the system will be able to locate the unscrupulous party by determining the unscrupulous party's IP address and actions can be taken to prosecute the unscrupulous party.

In another example, the system can add spurious information or markers into a credit card holder's account. In one example, the spurious information can include moving of the expiration date of the credit card, such that when the unscrupulous party uses the credit card with the false expiration date, the system can determine that a nefarious transaction is being attempted. Upon detecting the nefarious transaction, the system can be configured to identify, report, and/or display the nefarious transaction or can stop the transaction altogether.

There are many techniques for determining when a user's account has been compromised so the system can decide when to insert markers into the user's account. For example, the system can observe certain suspicious activity that is associated with unscrupulous parties attempting to access a user's account information or account peeking During account peeking, the unscrupulous party typically logs into a user's account for the sole purpose of obtaining the user's account information. For example, the unscrupulous party will log into the user's account to unlawfully take the user's account number, home address, email address, phone numbers, or other information.

In one example, account peeking can be detected by monitoring account access activity. This activity can be readily recognized by the system. The system can be configured to detect when unscrupulous parties repeatedly log into different accounts and view the same pieces of information repeatedly, over and over again. The system can be configured to detect this activity with the second iteration of the unscrupulous party attempting to log into user's accounts from the same IP address. Upon making a determination that certain activity is occurring, the system can be configured to insert spurious information into the user account information. For example, the system can detect when several accounts are accessed with the same IP address, and the markers can be inserted into the account information upon the detection of repeated logins from the same IP address. In conjunction or in the alternative to monitoring such activity, the system can also be configured to detect the speed and pattern at which the unscrupulous party accesses account information to help determine whether account peeking is occurring, and the markers can be inserted into the account information when a predetermined rate of logins across multiple user accounts occurs.

In another example, the system can monitor devices that are accessing user accounts for certain divisive computer programs (e.g., viruses, trojans, malware and the like), and the markers can be inserted into the account information based on the detection of divisive software on a device used to access the account information. In order to unlawfully take account information, an unscrupulous party may install a divisive program, such as malware, onto the account holder's device used to access their account. Such a program may allow the unscrupulous party to view the same information as the account holder such that the unscrupulous party can unlawfully take the account holder's information when the user accesses his/her account. The system can be configured to detect when a device is infected with a divisive program is used to access account information. When the system detects that the divisive program is installed on a device, it can be configured to insert spurious information into the account data, such as padding the account number with extra zeros.

III. Features of Cross Channel Scam Checking Methods and Systems According to Examples of the Disclosure

In one example, an apparatus comprising: a processor; and a memory for storing computer readable instructions that, when executed by the processor, can cause the apparatus to perform a method of screening a user account for nefarious activity. The apparatus can be configured to add one or more markers into the account information of the user account and scan for the one or more markers in transactions of the account across a plurality of transaction channels. The apparatus can also identify or display any transactions across the plurality of transaction channels that are conducted with the one or more markers.

The markers can be inserted into the account information upon the detection of repeated logins from the same IP address. In an alternative example, the markers can be inserted into the account information based on the detection of divisive software on a device used to access the account information. In another alternative example, the markers can be inserted into the account information upon a predetermined rate of logins across multiple user accounts.

In another example, the transaction can be automatically ceased when the one or more markers are detected. The markers can be included in an account number of a banking account. The transactions can be checking transactions and the method may also include determining whether the checking account number includes the one or more markers. The markers in the account number can be added when the account is accessed online and the markers can be detected during a checking transaction.

In another example a computer-implemented method can include using a processor to add one or more markers into account information of a user account, scanning with a processor for the one or more markers in transactions of the user account across a plurality of transaction channels, and identifying or reporting any transactions across the plurality of transaction channels that are conducted with the one or more markers. The markers can be inserted into the account information upon the detection of repeated logins from the same IP address. The markers can be inserted into the account information based on the detection of divisive software on a device used to access the account information. The markers can be inserted into the account information upon a predetermined rate of logins across multiple user accounts. The transaction can be automatically ceased when the one or more markers are detected. The account information may include an account number, and the markers can be included in the account number. The transactions can be checking transactions, and the method may further include determining whether the checking account number includes the one or more markers.

In other embodiments, one or more non-transitory computer-readable media may have instructions stored thereon that, when executed, cause at least one computing device to perform one or more aspects of the methods discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
a processor; and
memory storing computer readable instructions that, when executed by the processor, cause the apparatus to:
add one or more markers into account information of a user account;
scan for the one or more markers in transactions of the user account across a plurality of transaction channels; and
identify any transactions across the plurality of transaction channels that are conducted with the one or more markers.

2. The apparatus of claim 1, wherein the markers are inserted into the account information upon the detection of repeated logins from the same IP address.

3. The apparatus of claim 1 wherein the markers are inserted into the account information based on the detection of divisive software on a device used to access the account information.

4. The apparatus of claim 1, wherein the markers are inserted into the account information when a predetermined rate of logins across multiple user accounts occurs.

5. The apparatus of claim 1 wherein the transaction is automatically ceased when the one or more markers are detected.

6. The apparatus of claim 1 wherein the account information includes an account number and wherein the markers are included in the account number.

7. The apparatus of claim 6 wherein the markers in the account number are added when the account is accessed online and wherein the markers can be detected during a checking transaction.

8. A computer-implemented method comprising:
adding, by a computing device, one or more markers into account information of a user account;
scanning, by the computing device, for the one or more markers in transactions of the user account across a plurality of transaction channels; and
identifying, by the computing device, any transactions across the plurality of transaction channels that are conducted with the one or more markers.

9. The method of claim 8, wherein the markers are inserted into the account information upon the detection of repeated logins from the same IP address.

10. The method of claim 8 wherein the markers are inserted into the account information based on the detection of divisive software on a device used to access the account information.

11. The method of claim 8, wherein the markers are inserted into the account information upon a predetermined rate of logins across multiple user accounts.

12. The method of claim 8 wherein the transaction is automatically ceased when the one or more markers are detected.

13. The method of claim 8 wherein the account information includes an account number and wherein the markers are included in the account number.

14. The method of claim 13 wherein the markers in the account number are added when the account is accessed online and wherein the markers are detected during a checking transaction.

15. One or more non-transitory computer-readable media having instructions stored thereon that, when executed, cause at least one computing device to:
add one or more markers into account information of a user account;
scan for the one or more markers in transactions of the user account across a plurality of transaction channels; and
identify any transactions across the plurality of transaction channels that are conducted with the one or more markers.

16. The one or more non-transitory computer-readable media of claim 15, wherein the markers are inserted into the account information upon the detection of repeated logins from the same IP address.

17. The one or more non-transitory computer-readable media of claim 15 wherein the markers are inserted into the account information based on the detection of divisive software on a device used to access the account information.

18. The one or more non-transitory computer-readable media of claim 15, wherein the markers are inserted into the account information upon a predetermined rate of logins across multiple user accounts.

19. The one or more non-transitory computer-readable media of claim 15 wherein the transaction is automatically ceased when the one or more markers are detected.

20. The one or more non-transitory computer-readable media of claim 15 wherein the account information includes an account number and wherein the markers are included in the account number.
